(19) United States
(12) Patent Application Publication
(10) Pub. No.: US 2022/0056623 A1
(43) Pub. Date: Feb. 24, 2022

(54) COMPOSITE MATERIALS AND METHODS FOR MAKING THE SAME

(71) Applicant: Resolute FP Canada, Inc., Montreal (CA)

(72) Inventors: Shaune John HANLEY, Québec (CA); Otman OULANTI, Québec (CA); Norayr GURNAGUL, Québec (CA); Danielle GAGNÈ, Québec (CA)

(73) Assignee: Resolute FP Canada, Inc., Montreal (CA)

(21) Appl. No.: 17/413,908

(22) PCT Filed: Dec. 20, 2019
(86) PCT No.: PCT/US2019/067846

§ 371 Date: Jun. 14, 2021

Related U.S. Application Data
(60) Provisional application No. 62/784,462, filed on Dec. 23, 2018.

(51) Int. Cl. D04H 1/541; D04H 1/732; D04H 1/58; B27N 3/12; D04H 1/425; D04H 1/558

(52) U.S. Cl. CPC D04H 1/5412; D04H 1/732; D04H 1/558; B27N 3/12; D04H 1/425; D04H 1/58

(57) ABSTRACT

Disclosed herein are composite materials comprising a fibrous material and from 1% to 50% of a binding material, by weight of the composite material. Also disclosed herein are methods for making and using the same.

### FIELD OF THE DISCLOSURE

The present disclosure relates generally to composite materials and methods of manufacturing the same. Particularly, embodiments of the present disclosure relate to composite materials manufactured from mats comprising fibrous material and optionally binding materials.

### BACKGROUND

Composite materials can be useful in a variety of fields including, but not limited to, construction/infrastructure, transportation, automotive, marine, anticorrosion, electronics, aerospace, building, medical, sport/recreation, lawn/garden products, energy, water desalination, and ground tanks. Generally, composite materials (including, for instance, thermoset and thermoplastic) can be formed using man-made fibers such as glass fibers as the reinforcement material to achieve mechanical performance. Improved reinforced composites are desirable.

### BRIEF SUMMARY

Briefly described, embodiments of the presently disclosed subject matter generally relate to composite materials, and, more particularly, to highly compressed composite materials.

Disclosed herein are, for instance, composite materials comprising a fibrous material and a binding material. In some embodiments, the composite material comprises from 1% to 50% of the binding material, by weight of the composite material. In some embodiments, the fibrous material is a cellulosic fiber. In some embodiments, the cellulosic fiber is obtained from a wood pulp material. In some embodiments, the wood pulp material is southern bleached softwood kraft pulp. In some embodiments, the binding material is a bicomponent fiber. In some embodiments, the bicomponent fiber is a core-sheath fiber. In some embodiments, the core-sheath fiber comprises polyethylene terephthalate and polyethylene. Also disclosed herein are methods for manufacturing the disclosed composite materials.

In one aspect, the present invention provides a composite material comprising: from 1% to 99% by weight of a fibrous material comprising cellulosic fibers, by weight of the composite material; and from 1% to 50% by weight of a binding material, by weight of the composite material, wherein the composite material has a density of 0.8 g/cm³ to 1.5 g/cm³.

In some embodiments, the binding material comprises a bicomponent fiber, a monocomponent fiber, or a combination thereof. In some embodiments, the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.

In some embodiments, the density of the composite material is 1.1 g/cm³ to 1.4 g/cm³. In some embodiments, the composite material has a tensile strength of 15 MPa or greater, a flexural strength of 15 MPa or greater, or both. In some embodiments, the composite material has a tensile modulus of 0.75 GPa or greater, a flexural modulus of 0.75 GPa or greater, or both. In some embodiments, the composite material has a tensile strength of 50 MPa or greater, a flexural strength of 50 MPa or greater, or both.

In another aspect, the present invention provides a method comprising: heating a mat to a temperature; and compressing the mat at a first pressure of 800 psi to 6000 psi into one of a two-dimensional panel or a three-dimensional shape; wherein the mat comprises: from 1% to 99% by weight of a fibrous material comprising cellulosic fibers; and from 1% to 50% by weight of a binding material, wherein the temperature is above the melting point of the binding material, and wherein the mat is incorporated into a composite material.

In any of the embodiments disclosed herein, the method further comprises cooling the two-dimensional panel or three-dimensional shape to a temperature below the melting point of the binding material after the step of compressing the mat.

In some embodiments, the temperature is from 40° C. to 200° C.

In any of the embodiments disclosed herein, the method further comprises forming the two-dimensional panel into a contoured two-dimensional panel or three-dimensional shape at a second pressure of 15 psi to 500 psi.

In some embodiments, the first pressure is from 850 psi to 5000 psi. In some embodiments, the heating and compressing are simultaneous.

In any of the embodiments disclosed herein, the method further comprises comprising cooling the contoured two-dimensional panel or three-dimensional shape to a temperature below the melting point of the binding material after the step of forming the two-dimensional panel.

In some embodiments, the first and/or second pressure occurs at a temperature is above the melting point of the binding material.

In some embodiments, the binding material comprises a bicomponent fiber, a monocomponent fiber, or a combination thereof. In some embodiments, the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.

In some embodiments, the composite material has a tensile modulus of 0.75 GPa or greater, a flexural modulus of 0.75 GPa or greater, or both. In some embodiments, the composite material has a tensile strength of 50 MPa or greater, a flexural strength of 50 MPa or greater, or both. In some embodiments, the density of the contoured two-dimensional panel or the three-dimensional shape is substantially the same as that of a two-dimensional panel.

In some embodiments, the mat is a wetlaid mat. In some embodiments, the mat is an airlaid mat.

In another aspect, the present invention provides a composite material produced by any of the methods described herein, wherein the composite material has a density of 1.1 g/cm³ to 1.4 g/cm³.

### BRIEF DESCRIPTION OF THE DRAWINGS

FIG. 1 illustrates the effects of pressing pressure on tensile strength in accordance with some embodiments disclosed herein.

FIG. 2 illustrates the effects of pressing pressure on tensile modulus in accordance with some embodiments disclosed herein.

FIG. 3 illustrates the effects of pressing pressure on flexural strength in accordance with some embodiments disclosed herein.

FIG. 4 illustrates the effects of pressing pressure on flexural modulus in accordance with some embodiments disclosed herein.

FIG. 5 shows a highly compressed composite material in accordance with some embodiments disclosed herein.

FIG. 6 illustrates a flow chart of a manufacturing process for making a reinforced composite according to some embodiments of the present disclosure.

FIG. 7 shows a comparison of tensile strengths of composite materials made from different manufacturing processes according to embodiments of the present disclosure.

FIG. 8 shows a comparison of flexural strengths of composite materials made from different manufacturing processes according to embodiments of the present disclosure.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named. In other words, the terms “a,” “an,” and “the” do not denote a limitation of quantity, but rather denote the presence of “at least one” of the referenced item.

As used herein, the term “and/or” may mean “and,” it may mean “or,” it may mean “exclusive-or,” it may mean “one,” it may mean “some, but not all,” it may mean “neither,” and/or it may mean “both.” The term “or” is intended to mean an inclusive “or.”

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value. Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Further, the term “about” means within an acceptable error range for the particular value as determined by one of ordinary skill in the art, which will depend in part on how the value is measured or determined, i.e., the limitations of the measurement system. For example, “about” can mean within an acceptable standard deviation, per the practice in the art. Alternatively, “about” can mean a range of up to ±20%, preferably up to ±10%, more preferably up to ±5%, and more preferably still up to ±1% of a given value. Alternatively, particularly with respect to biological systems or processes, the term can mean within an order of magnitude, preferably within 2-fold, of a value. Where particular values are described in the application and claims, unless otherwise stated, the term “about” is implicit and in this context means within an acceptable error range for the particular value.

Throughout this description, various components may be identified having specific values or parameters, however, these items are provided as exemplary embodiments. Indeed, the exemplary embodiments do not limit the various aspects and concepts of the present invention as many comparable parameters, sizes, ranges, and/or values may be implemented. The terms “first,” “second,” and the like, “primary,” “secondary,” and the like, do not denote any order, quantity, or importance, but rather are used to distinguish one element from another.

It is noted that terms like “specifically,” “preferably,” “typically,” “generally,” and “often” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Further, the term “about” means within an acceptable error range for the particular value as determined by one of ordinary skill in the art, which will depend in part on how the value is measured or determined, i.e., the limitations of the measurement system. For example, “about” can mean within an acceptable standard deviation, per the practice in the art. Alternatively, “about” can mean a range of up to ±20%, preferably up to ±10%, more preferably up to ±5%, and more preferably still up to ±1% of a given value. Alternatively, particularly with respect to biological systems or processes, the term can mean within an order of magnitude, preferably within 2-fold, of a value. Where particular values are described in the application and claims, unless otherwise stated, the term “about” is implicit and in this context means within an acceptable error range for the particular value. Similarly, the term “substantially” means within an acceptable error range for the particular value as determined by one of ordinary skill in the art, which will depend in part on how the value is measured or determined, i.e., the limitations of the measurement system. For example, “substantially” can mean within an acceptable standard deviation, per the practice in the art. Alternatively, “substantially” can mean a range of up to ±10%, preferably up to ±5%, and more preferably up to ±1% of a given value.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “50 mm” is intended to mean “about 50 mm.”

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Disclosed herein are composite materials comprising a fibrous material. In some embodiments, the fibrous material comprises natural fibers. In some embodiments, the fibrous material includes cellulosic fibers. In some embodiments, the fibrous material comprises wood fibers. In some embodiments, the wood fibers can be provided in the form of a wood pulp or other fibrous source. For instance, the wood fibers can be provided in the form of southern bleached softwood kraft pulp. For instance, the wood fibers can be provided in the form of northern bleached softwood kraft pulp. Suitable examples of fibrous sources can include, but are not limited to, kraft pulp, fluff pulp, dissolving pulp, mechanical pulp, chemical pulp, chemical-mechanical pulp, recovered paper pulp, semi-mechanical pulp, semi-chemical pulp, soft cook fully chemical pulp, consumer waste products such as clothes, viscose, rayon, lyocell, or any combination thereof. Other suitable examples of wood fibers include hardwood, softwood, aspen, balsa, beech, birch, mahogany, hickory, maple, oak, teak eucalyptus, pine, fir, cedar, juniper, spruce, redwood, or any combination thereof. It is understood that any other known sources of wood fibers may be used. In some embodiments, the airlaid mat can comprise of fibrous material in the form of natural non-wood or alternative fibers. Suitable examples of natural non-wood alternative fibers that can make up the fibrous material in the airlaid mat can include barley, bagasse, bamboo, wheat, flax, hemp, kenaf, Arundo donax, corn stalk, jute, ramie, cotton, wool, rye, rice, papyrus, esparto, sisal, grass, abaca, or a combination thereof. It is understood that the fibrous material can include any other natural fibers from any source or any combination of natural fibers. In some embodiments, the fibrous material can be provided from cellulosic fibers that can be prepared from the wood pulp or otherwise provided fiber source by means of a mechanical process such as hammermilling or other defiberization processes.

In some embodiments, fibrous material can further comprise synthetic fiber. In some embodiments, the synthetic fiber can include glass fibers, alumina silica fibers, aluminum oxide fibers, silica fibers, carbon fibers, metal fibers, ceramic fibers, aramid fibers, or a combination thereof. In some embodiments, the fibrous material comprises natural fiber to synthetic fiber ratio of 1:1 to 1:100 (e.g., 1:1.25, 1:5, 1:1.75, 1:2, 1:3, 1:4, 1:5, 1:6, 1:7, 1:8, 1:9, 1:10, 1:20, 1:30, 1:40, 1:50, 1:75, 1:100).

The fibrous material can be provided in the form including, but not limited to, staple fibers, spun fibers, continuous filament fibers, or a combination thereof. For instance, the fibrous material can comprise natural staple fibers, continuous filament synthetic fibers, or a combination thereof. In some embodiments, the fibrous material can comprise fibers having an average length from approximately 0.01 mm to 12 mm. For example, the fibrous material can comprise fibers having an average length of 0.01 mm or greater (e.g., 0.05 mm or greater, 0.10 mm or greater, 0.15 mm or greater, 0.20 mm or greater, 0.25 mm or greater, 0.30 mm or greater, 0.35 mm or greater, 0.40 mm or greater, 0.45 mm or greater, 0.50 mm or greater, 0.55 mm or greater, 0.60 mm or greater, 0.65 mm or greater, 0.70 mm or greater, 0.75 mm or greater, 0.80 mm or greater, 0.85 mm or greater, 0.90 mm or greater, 0.95 mm or greater, 1.0 mm or greater, 1.1 mm or greater, 1.2 mm or greater, 1.3 mm or greater, 1.4 mm or greater, 1.5 mm or greater, 1.6 mm or greater, 1.7 mm or greater, 1.8 mm or greater, 1.9 mm or greater, 2.0 mm or greater, 2.1 mm or greater, 2.2 mm or greater, 2.3 mm or greater, 2.4 mm or greater, 2.5 mm or greater, 2.6 mm or greater, 2.7 mm or greater, 2.8 mm or greater, 2.9 mm or greater, 3.0 mm or greater, 3.5 mm or greater, 4.0 mm or greater, 4.5 mm or greater, 5.0 mm or greater, 5.5 mm or greater, 6.0 mm or greater, 6.5 mm or greater, 7.0 mm or greater, 7.5 mm or greater, 8.0 mm or greater, 8.5 mm or greater, 9.0 mm or greater, 9.5 mm or greater, 10 mm or greater, 10.5 mm or greater, 11 mm or greater, or 11.5 mm or greater). In some embodiments, the fibrous material can comprise fibers having an average length of 12 mm or less (e.g., 11.5 mm or less, 11 mm or less, 10.5 mm or less, 10 mm or less, 9.5 mm or less, 9.0 mm or less, 8.5 mm or less, 8.0 mm or less, 7.5 mm or less, 7.0 mm or less, 6.5 mm or less, 6.0 mm or less, 5.5 mm or less, 5.0 mm or less, 4.5 mm or less, 4.0 mm or less, 3.5 mm or less, 3.0 mm or less, 2.9 mm or less, 2.8 mm or less, 2.7 mm or less, 2.6 mm or less, 2.5 mm or less, 2.4 mm or less, 2.3 mm or less, 2.2 mm or less, 2.1 mm or less, 2.0 mm or less, 1.9 mm or less, 1.8 mm or less, 1.7 mm or less, 1.6 mm or less, 1.5 mm or less 1.4 mm or less, 1.3 mm or less, 1.2 mm or less, 1.1 mm or less, 1.0 mm or less, 0.95 mm or less, 0.90 mm or less, 0.85 mm or less, 0.80 mm or less, 0.75 mm or less, 0.70 mm or less, 0.65 mm or less, 0.60 mm or less, 0.55 mm or less, 0.50 mm or less, 0.45 mm or less, 0.40 mm or less, 0.35 mm or less, 0.30 mm or less, 0.25 mm or less, 0.20 mm or less, 0.15 mm or less, 0.10 mm or less, 0.05 mm or less). In some embodiments, the fibrous material has a length of 0.01 mm to 12 mm (e.g., 0.3 mm to 7 mm, 0.5 mm to 5 mm, 0.7 mm to 2.8 mm, 2.9 mm to 8 mm, 8 mm to 12 mm, 0.01 mm to 1 mm). In some embodiments, the fibrous material comprises a blend of one or more fibers (natural and/or synthetic) that are of different average fiber lengths. In other words, in some embodiments, the fibrous material has bimodal (or trimodal, etc.) average fiber length.

In some embodiments, the fibrous material can comprise fibers having various cross-sectional shapes (e.g., round, scalloped oval, cruciform, haxachannel, etc.). In some embodiments, the average maximum cross-sectional size of the fibers in the fibrous material (i.e., the average diameter for a round fiber) is from 100 nanometers to 100 microns. In some embodiments, the fibrous material can have an average maximum cross-sectional size of 100 nanometers or greater (e.g., 150 nanometers or greater, 250 nanometers or greater, 350 nanometers or greater, 450 nanometers or greater, 550 nanometers or greater, 650 nanometers or greater, 750 nanometers or greater, 850 nanometers or greater, 950 nanometers or greater, 1 micron or greater, 5 microns or greater, 10 microns or greater, 15 microns or greater, 20 microns or greater, 25 microns or greater, 30 microns or greater, 35 microns or greater, 40 microns or greater, 45 microns or greater, 50 microns or greater, 55 microns or greater, 60 microns or greater, 65 microns or greater, 70 microns or greater, 75 microns or greater, 80 microns or greater, 85 microns or greater, 90 microns or greater, 95 microns or greater). In some embodiments, the fibrous material can have an average maximum cross-sectional size of 100 microns or less (e.g., 95 microns or less, 90 microns or less, 85 microns or less, 80 microns or less, 75 microns or less, 70 microns or less, 65 microns or less, 60 microns or less, 55 microns or less, 50 microns or less, 45 microns or less, 40 microns or less, 35 microns or less, 30 microns or less, 25 microns or less, 20 microns or less, 15 microns or less, 10 microns or less, 5 microns or less, 1 micron or less, 900 nanometers or less, 800 nanometers or less, 700 nanometers or less, 600 nanometers or less, 500 nanometers or less, 400 nanometers or less, 300 nanometers or less, 200 nanometers or less). In some embodiments, the fibrous material can have an average maximum cross-sectional size of 100 nanometers to 100 microns (e.g., 100 nanometers to 1 micron, 1 micron to 10 microns, 10 microns to 25 microns, 25 microns to 50 microns, 50 microns to 75 microns, 75 microns to 100 microns, 25 microns to 75 microns, 25 microns to 100 microns, 100 nanometers to 10 microns, 100 nanometers to 25 microns, 1 micron to 25 microns, 10 microns to 75 microns). In some embodiments, the fibrous material comprises a blend of one or more fibers (natural and/or synthetic) that are of different average maximum cross-sectional size. In other words, in some embodiments, the fibrous material has bimodal (or trimodal, etc.) average maximum cross-sectional size.

The mats disclosed herein can be formed by any processes, such as airlaid processes and wetlaid processes. A reference to “mat” therefore includes mats made by any process.

The composite materials disclosed herein can further comprise a binding material. In some embodiments, the binding material comprises a binder fiber. In some embodiments, the binding material comprises a polymer. In some embodiments, the binding material comprises a thermoplastic fiber. In some embodiments, the binding material comprises a biodegradable fiber. The binding material can include, but is not limited to, polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or any combination thereof.

In some embodiments, the binding material can comprise a monocomponent fiber. In some embodiments, the binding material can comprise a bicomponent fiber. In some embodiments, the binding material can comprise a tricomponent fiber. In some embodiments, the binding material can comprise a mix of monocomponent fibers. In some embodiments, the binding material can comprise a mix of bicomponent fibers. In some embodiments, the binding material can comprise a mix of monocomponent fibers and bicomponent fibers. In some embodiments, the binding material can comprise monocomponent fibers, bicomponent fibers, tricomponent fibers, or a combination thereof. Example bicomponent fiber configurations include, but are not limited to, core-sheath, side-by-side, segmented-pie, islands-in-the-sea, tipped, segmented-ribbon, or a combination thereof. A bicomponent fiber can include a fiber formed from two varieties of a single polymer type and can structurally comprise a core polymer and a sheath polymer. If the core and sheath polymers are varieties of the same polymer, they can retain their polymeric identity but have different melting points, which can render the bicomponent fibers useful as bonding agents. The core and sheath polymers can also comprise separate polymers. A person of ordinary skill in the art would recognize that the melting point of the sheath polymer varies depending on the composition of the sheath polymer, and that the bicomponent fibers can be heated in some embodiments to a temperature sufficient for bonding (e.g., above the melting point of the sheath polymer but below the melting temperature of the core polymer).

As discussed in more detail below, the fibrous material and binding material can form mats that can be compressed at a certain temperature. In some embodiments, the temperature at which the mat is compressed can depend on the melting temperature of the binding material of the mat. In some embodiments, the temperature at which the mat is compressed can depend on the melting temperature of the bicomponent fiber. In some embodiments, the temperature at which the mat is compressed can depend on the polymer or polymers comprising the bicomponent fiber. For example and not limitation, the temperature at which the mat is compressed can depend on the melting temperature(s) of the polymer(s) comprising the core and/or the sheath of the bicomponent fiber.

In some embodiments, the bicomponent fiber can comprise polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA), polybutylene, and any combination thereof. Any of these polymers can be present in the sheath or the core in any combination, provided that the polymer that is in the sheath has a lower melting temperature than the polymer that is in the core. In some embodiments, the core of the bicomponent fiber can comprise one or more of polyester (which can have a melting temperature of from about 250° C. to about 280° C.), the sheath of the bicomponent fiber can be a polyethylene (which can have a melting temperature of from about 100° C. to about 115° C. for low-density polyethylene and from about 115° C. to about 180° C. for medium- to high-density polyethylene) and/or polypropylene (which can have a melting temperature of from about 130° C. to about 170° C.). In some embodiments, the bicomponent fibers can comprise a core polymer and a sheath polymer. In some embodiments, the core polymer can comprise one or more of a polyester, a polyethylene, and/or a polypropylene. In some embodiments, the core polymer can be selected from the group consisting of a polyester, a polyethylene, a polypropylene, a polyethylene terephthalate, and a polybutylene terephthalate. In some embodiments, the sheath polymer can comprise one or more of a polyester, a polyethylene, and/or a polypropylene. In some embodiments, the sheath polymer can be selected from the group consisting of a polyester, a polyethylene, and a polypropylene. In some embodiments, the bicomponent fiber can comprise a polyester core and a polycaprolactone or polylactic acid sheath. In some embodiments, the bicomponent fiber can comprise a polyester core and a polyethylene sheath. In some embodiments, the bicomponent fiber can comprise a polypropylene core and a polyethylene sheath. In some embodiments, the bicomponent fiber can comprise a polyethylene terephthalate core and a polyethylene sheath. In some embodiments, the bicomponent fiber can comprise a polylactic acid core and a polybutylene succinate sheath. In some embodiments, the bicomponent fiber can be composed of a core polymer having a higher melting temperature than the sheath polymer. A person of ordinary skill in the art would recognize that any suitable bicomponent fiber, monocomponent fiber, or combination thereof would work in the embodiments disclosed herein and can include any thermoplastic polymer (or combination of thermoplastic polymers) disclosed herein or later discovered. In some embodiments, the binding material is a tricomponent fiber (e.g., core-sheath-sheath). It is to be understood that any variety of polymers can be used in the binding material, with any variety of properties and melting points, and in any configuration (e.g., monocomponent, bicomponent, islands-in-the-sea, etc.) to achieve the desired properties in the resulting composite material or intermediary (e.g., airlaid mat) thereof.

The binding material can be provided as a binder fiber in the form including, but not limited to, staple fibers, spun fibers, continuous filament fibers, or a combination thereof. In some embodiments, the binder fiber has average length from 0.01 mm to 12 mm. For example, the binder fiber can have an average length of 0.01 mm or greater (e.g., 0.05 mm or greater, 0.10 mm or greater, 0.15 mm or greater, 0.20 mm or greater, 0.25 mm or greater, 0.30 mm or greater, 0.35 mm or greater, 0.40 mm or greater, 0.45 mm or greater, 0.50 mm or greater, 0.55 mm or greater, 0.60 mm or greater, 0.65 mm or greater, 0.70 mm or greater, 0.75 mm or greater, 0.80 mm or greater, 0.85 mm or greater, 0.90 mm or greater, 0.95 mm or greater, 1.0 mm or greater, 1.1 mm or greater, 1.2 mm or greater, 1.3 mm or greater, 1.4 mm or greater, 1.5 mm or greater, 1.6 mm or greater, 1.7 mm or greater, 1.8 mm or greater, 1.9 mm or greater, 2.0 mm or greater, 2.1 mm or greater, 2.2 mm or greater, 2.3 mm or greater, 2.4 mm or greater, 2.5 mm or greater, 2.6 mm or greater, 2.7 mm or greater, 2.8 mm or greater, 2.9 mm or greater, 3.0 mm or greater, 3.5 mm or greater, 4.0 mm or greater, 4.5 mm or greater, 5.0 mm or greater, 5.5 mm or greater, 6.0 mm or greater, 6.5 mm or greater, 7.0 mm or greater, 7.5 mm or greater, 8.0 mm or greater, 8.5 mm or greater, 9.0 mm or greater, 9.5 mm or greater, 10 mm or greater, 10.5 mm or greater, 11 mm or greater, or 11.5 mm or greater). In some embodiments, the binder fiber can have an average length of 12 mm or less (e.g., 11.5 mm or less, 11 mm or less, 10.5 mm or less, 10 mm or less, 9.5 mm or less, 9.0 mm or less, 8.5 mm or less, 8.0 mm or less, 7.5 mm or less, 7.0 mm or less, 6.5 mm or less, 6.0 mm or less, 5.5 mm or less, 5.0 mm or less, 4.5 mm or less, 4.0 mm or less, 3.5 mm or less, 3.0 mm or less, 2.9 mm or less, 2.8 mm or less, 2.7 mm or less, 2.6 mm or less, 2.5 mm or less, 2.4 mm or less, 2.3 mm or less, 2.2 mm or less, 2.1 mm or less, 2.0 mm or less, 1.9 mm or less, 1.8 mm or less, 1.7 mm or less, 1.6 mm or less, 1.5 mm or less 1.4 mm or less, 1.3 mm or less, 1.2 mm or less, 1.1 mm or less, 1.0 mm or less, 0.95 mm or less, 0.90 mm or less, 0.85 mm or less, 0.80 mm or less, 0.75 mm or less, 0.70 mm or less, 0.65 mm or less, 0.60 mm or less, 0.55 mm or less, 0.50 mm or less, 0.45 mm or less, 0.40 mm or less, 0.35 mm or less, 0.30 mm or less, 0.25 mm or less, 0.20 mm or less, 0.15 mm or less, 0.10 mm or less, 0.05 mm or less). In some embodiments, the binder fiber has a length of 0.01 mm to 12 mm (e.g., 0.3 mm to 7 mm, 0.5 mm to 5 mm, 0.7 mm to 2.8 mm, 2.9 mm to 8 mm, 8 mm to 12 mm, 0.01 mm to 1 mm).

In some embodiments, the binder fiber comprises a blend of one or more fibers (e.g., monocomponent fibers and bicomponent fibers, two different bicomponent fibers, two different monocomponent fibers) that are of different average fiber lengths. In other words, in some embodiments, the binder fiber has bimodal (or trimodal, etc.) average fiber length.

In some embodiments, the binder fiber can comprise fibers having various cross-sectional shapes (e.g., round, scalloped oval, cruciform, haxachannel, etc.). In some embodiments, the average maximum cross-sectional size of the fibers in the binder fiber (i.e., the average diameter for a round fiber) varies depending on how the binder fibers are made and can be manipulated to achieve different outcomes for the reinforced composite or any intermediaries (e.g., airlaid mat) thereof. For instance, in some embodiments, the binder fiber can comprise fibers of 1 dtex to 10 dtex (e.g., 1.3 dtex to 2.5 dtex, 5 dtex to 7 dtex).

The composite materials disclosed herein can comprise a fibrous material and a binder fiber. The composite material can comprise the fibrous material in any suitable amount to confer a desirable property to the composite material and/or any intermediaries (e.g., airlaid mat, wetlaid mat). In some embodiments, the fibrous material can be present in the composite material in amounts of 50% or greater (e.g., 55% or greater, 60% or greater, 65% or greater, 70% or greater, 75% or greater, 80% or greater, 81% or greater, 82% or greater, 83% or greater, 84% or greater, 85% or greater, 86% or greater, 87% or greater, 88% or greater, 89% or greater, 90% or greater, 91% or greater, 92% or greater, 93% or greater, 94% or greater, 95% or greater, 96% or greater, 97% or greater, 98% or greater) by weight, based on the total weight of the composite material. In some embodiments, the fibrous material can be present in the composite material in amounts of 99% or less (e.g., 98% or less, 97% or less, 96% or less, 95% or less, 94% or less, 93% or less, 92% or less, 91% or less, 90% or less, 89% or less, 88% or less, 87% or less, 86% or less, 85% or less, 84% or less, 83% or less, 82% or less, or 81% or less, 80% or less, 75% or less, 70% or less, 65% or less, 60% or less, 55% or less), by weight, based on the total weight of the composite material.

The composite material can comprise the binding material in any suitable amount to confer a desirable property to the composite material and/or any intermediaries (e.g., airlaid or wetlaid mat). In some embodiments, the composite material comprises no binding material. In some embodiments, the binding material can be present in the composite material in an amount of 1% to 50%, by weight of the composite material. In some embodiments, the binding material is present in an amount of 1% or greater (e.g., 2% or greater, 4% or greater 6% or greater, 8% or greater, 10% or greater, 15% or greater, 20% or greater, 25% or greater, 30% or greater, 35% or greater, 40% or greater, 45% or greater) by weight, based on the total weight of the composite material. In some embodiments, the binding material can be present in the composite material in amounts of 50% or less (e.g., 45% or less, 40% or less, 35% or less, 30% or less, 25% or less, 20% or less, 15% or less, 10% or less, 8% or less, 6% or less, 4% or less, 2% or less) by weight, based on the total weight of the composite material. In some embodiments, the binding material is present in the composite material in an amount of 1% to 50% (e.g., 1% to 10%, 5% to 15%, 10% to 20%, 20% to 30%, 30% to 40%, 40% to 50%, 1% to 20%, 1% to 25%, 5% to 25%, 1% to 30%, 40% to 50%).

The weight percentages of the fibrous material and the binding material can also affect the density and one or more mechanical properties of the composite material. The weight percentage of the bicomponent material can be 5% by weight of the composite material, 20% by weight of the composite material, 25% by weight of the composite material, and 50% by weight of the composite material. For example, increasing the amount of the binding material can increase one or more of the density, tensile strength, tensile modulus, flexural strength, and flexural modulus of the composite material produced by any of the methods described herein.

In some embodiments, the binding material comprises a binder fiber. In some embodiments, the binding material comprises a liquid binder. In some embodiments, the binding material comprises a binder fiber and liquid binder. In some embodiments, the liquid binder can include latex, polylactic acid, styrene maleic anhydride copolymer, styrene-acrylate copolymer, carboxymethyl cellulose, hydroxymethyl cellulose, starch, dextrin, collagen, styrene butadiene latex, styrene acrylic, epichlorohydrin, polyvinyl alcohol, melamine, urea formaldehyde, or a combination thereof.

In some embodiments, the binding material is in the form of particles. In some embodiments, the binding material has an average particle size of 0.1 micron to 1 micron (e.g., 0.1 micron to 0.2 micron, 0.2 micron to 0.4 micron, 0.4 micron to 0.6 micron, 0.6 micron to 0.8 micron, 0.8 micron to 1 micron). In some embodiments, the binding material has an average particle size of 1 micron or less (e.g., 0.95 microns or less, 0.90 microns or less, 0.85 microns or less, 0.80 microns or less, 0.7 microns or less, 0.6 microns or less, 0.5 microns or less, 0.4 microns or less, 0.3 microns or less, 0.2 microns or less, 0.1 microns or less). In some embodiments, the binding material has an average particle size of 0.1 micron or greater (e.g., 0.95 microns or greater, 0.90 microns or greater, 0.85 microns or greater, 0.80 microns or greater, 0.7 microns or greater, 0.6 microns or greater, 0.5 microns or greater, 0.4 microns or greater, 0.3 microns or greater, 0.2 microns or greater). In some embodiments, the binding material comprises a blend of one or more particles that are of different average particle size. In other words, in some embodiments, the binding material has bimodal (or trimodal, etc.) average particle size.

The composite materials can be manufactured according to a variety of processes. In some embodiments, the composite materials are manufactured by compressing one or more airlaid mats that comprise a fibrous material and a binding material. In some embodiments, the composite materials are manufactured by compressing one or more wetlaid mats comprising a fibrous material. While some embodiments of this disclosure relate to airlaid mats manufactured by a standard airlaying process, it is understood that the mat can alternatively be manufactured using any non-woven process, such as carding, crosslapping, melt-blown, flash spun, drylaying, wetlaying, or spunbound.

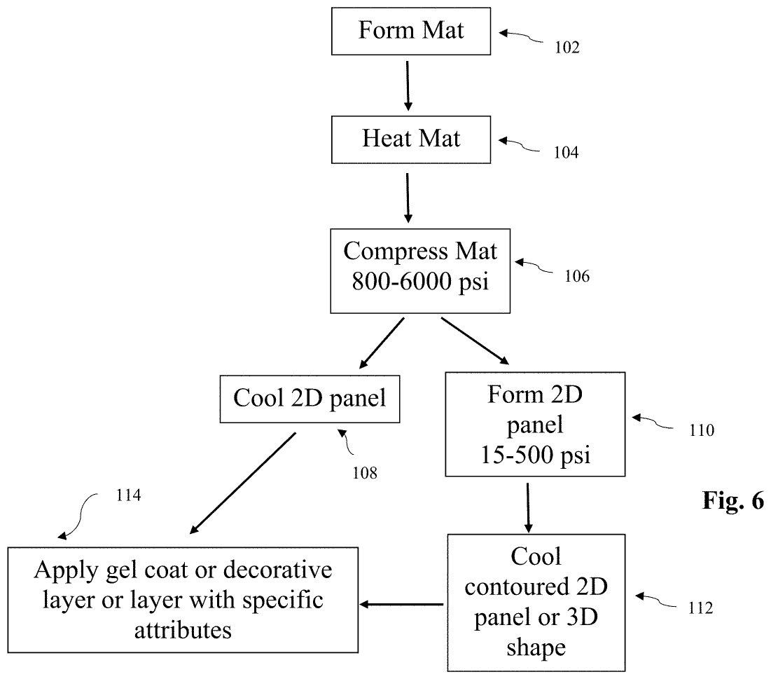

FIG. 6 illustrates a flow chart of a manufacturing process for making some embodiments of composite materials disclosed herein. The process steps can be represented graphically as a series of steps that, in the embodiments disclosed in FIG. 6, can include an airlaid mat or a wetlaid mat. A person of ordinary skill in the art would understand that some or all process steps can have some or all features discussed above regarding the component parts. In. FIG. 6, a mat can be formed at 102. If the mat is an airlaid mat, for instance, it can be formed using any device known in the art that can form airlaid mats. Those skilled in the art would understand that an airlaid mat can be formed by a device generally including a fiber feed for providing the fibrous material, a refiner (e.g., a defibrator), a forming head for receiving the defibrated fibrous material and binding materials to form a web, and a conveyor on which the web is compacted. If the mat is a wetlaid mat, it can be formed by any wetlaid process known to a person of ordinary skill in the art. For example, a wetlaid mat can comprise one or more of the steps of providing a slurry comprising fibrous material and water deposited onto a moving wire screen that is drained to form a web, wherein the web is further dewatered and consolidated (e.g., by pressing between rollers) and dried. Before forming the mat, the fibrous materials are surfaced treated. In some embodiments, the fibrous materials are surface treated to improve the chemical and/or mechanical properties of the fibrous materials or resulting mats and composite materials. The fibrous materials can be surface treated using chemical and/or physical surface treatments. In some embodiments, the surface treatment includes adhesive treatment, adding/removing static charges between fibers, electric discharge, mercerization, graft copolymerization, peroxide treatment, vinyl grafting, bleaching, acetylation, coupling-agent treatment, isocyanate treatment, or combinations thereof. In some embodiments, the fibrous materials are surface treated to increase the bonding between the fibrous material and binding material, provide water resistance to the fibers, decrease static between fibers, change the physical appearance of the fibers, and various other property enhancements known to those of ordinary skill in the art.

In some embodiments, the composite material can have multiple layers of mats laminated together. For instance, in some embodiments the composite material can comprise 1 layer, 2 layers, 3 layers, 4 layers, 5 layers, or 6 layers of mats. It is understood that, depending on the use, the number of layers can exceed 6 layers or mats. In some embodiments, the layers can be laminated together or otherwise joined before or during the compression process. In some embodiments, the layers of mats differ from one another. In some embodiments, the mat can include airlaid mat layer and wetlaid mat layer. In some embodiments, the mat can include multiple different airlaid mat layers. In some embodiments, the mat can include multiple different wetlaid mat layers. In some embodiments, the mat can include a sandwich structure of layers, for instance with multiple different airlaid mat layers outside and wetlaid mat layer inside. In some embodiments, the mat can include a sandwich structure of layers, for instance with multiple different wetlaid mat layers outside and airlaid mat layer inside. The properties of the mat can be varied based on a variety of factors (e.g., binding material type and amount, etc.). In some embodiments, the one or more layers of the mats can have a weight of 350 gsm (grams per square meter) to 4000 gsm. For instance, the one or more layers of the mats can have a weight of 350 gsm or greater (e.g., 400 gsm or greater, 500 gsm or greater, 600 gsm or greater, 700 gsm or greater, 800 gsm or greater, 900 gsm or greater, 1000 gsm or greater, 1500 gsm or greater, 1700 gsm or greater, 2000 gsm or greater, 2100 gsm or greater, 2300 gsm or greater, 2500 gsm or greater, 2700 gsm or greater, 3000 gsm or greater, or 3500 gsm or greater). For instance, the one or more layers of the mats can have a weight of 4000 gsm or less (e.g., 3750 gsm or less, 3250 gsm or less, 3000 gsm or less, 2750 gsm or less, 2500 gsm or less, 2250 gsm or less, 2000 gsm or less, 1750 gsm or less, 1500 gsm or less, 1250 gsm or less, 1000 gsm or less, 750 gsm or less, or 500 gsm or less). For instance, the one or more layers of the mats can have a weight of from 350 gsm to 4000 gsm (e.g., 350 gsm to 400 gsm, 400 gsm to 500 gsm, 500 gsm to 600 gsm, 600 gsm to 700 gsm, 700 gsm to 800 gsm, 800 gsm to 900 gsm, 900 gsm to 1000 gsm, 1000 gsm to 1500 gsm, 1500 gsm to 2000 gsm, 2000 gsm to 2500 gsm, 3000 gsm to 3500 gsm, or 3500 gsm to 4000 gsm. A person of ordinary skill in the art would recognize that the weight of the airlaid mat can be expanded above or below the ranges (above in this paragraph) as needed for various other applications and uses.

In some embodiments, the density of the mat is from 0.2 g/cm³ to 1.4 g/cm³ (e.g., 0.2 g/cm³ to 0.4 g/cm³, 0.4 g/cm³ to 0.6 g/cm³, 0.6 g/cm³ to 0.8 g/cm³, 0.8 g/cm³ to 1.0 g/cm³, 1.0 g/cm³ to 1.2 g/cm³, 1.2 g/cm³ to 1.4 g/cm³, 0.8 g/cm³ to 1.1 g/cm³, 0.8 g/cm³ to 1.2 g/cm³, 0.8 g/cm³ to 1.3 g/cm³). In some embodiments, the density of the mat is from 0.2 g/cm³ or greater (e.g., 0.2 g/cm³ or greater, 0.4 g/cm³ or greater, 0.6 g/cm³ or greater, 0.8 g/cm³ or greater, 1.0 g/cm³ or greater, 1.2 g/cm³ or greater). In some embodiments, the density of the mat is from 1.4 g/cm³ or less (e.g., 1.2 g/cm³ or less, 1.0 g/cm³ or less, 0.8 g/cm³ or less, 0.6 g/cm³ or less, 0.4 g/cm³ or less).

In some embodiments, the thickness of the mat is from 50 mm to 100 mm for a 1000 gsm mat. In some embodiments, the thickness of the mat is from 50 mm to 100 mm (e.g., 50 mm to 60 mm, 60 mm to 70 mm, 70 mm to 80 mm, 80 mm to 90 mm, 90 mm to 100 mm). In some embodiments, the thickness of the mat is 50 mm or greater (e.g., 50 mm or greater, 60 mm or greater, 70 mm or greater, 80 mm or greater, 90 mm or greater). In some embodiments, the thickness of the mat is 100 mm or less (e.g., 90 mm or less, 80 mm or less, 70 mm or less, 60 mm or less).

After forming the mat, the mat can be heated at 104 in FIG. 6 to a temperature. In some embodiments, the heating can be performed in a hot press, an infrared system, or an oven. In some embodiments, the temperature chosen can be based on the melting temperature of the binding materials. In some embodiments, the 2D or 3D mold itself can be heated. In some embodiments, the temperature chosen is at or above the melting temperature of the binding material (e.g., binder fibers). In embodiments where the binding materials are bicomponent fibers, the temperature can be chosen to be at or above the melting temperature of the sheath of the bicomponent fiber, for instance, as discussed above. In other embodiments, the mat can be heated in a 2D or 3D mold or heated in an oven or infrared system and then transferred to a mold. In some embodiments, the temperature can be from 40° C. to 200° C. (e.g., 40° C. to 50° C., 50° C. to 100° C., 100° C. to 140° C., 140° C. to 200° C., 150° C. to 180° C.). In some embodiments, the temperature is 40° C. or greater (e.g., 50° C. or greater, 60° C. or greater, 70° C. or greater, 80° C. or greater, 90° C. or greater, 100° C. or greater, 110° C. or greater, 120° C. or greater, 130° C. or greater, 140° C. or greater, 150° C. or greater, 160° C. or greater, 170° C. or greater, 180° C. or greater, 190° C. or greater). In some embodiments, the temperature is 200° C. or less (e.g., 50° C. or less, 60° C. or less, 70° C. or less, 80° C. or less, 90° C. or less, 100° C. or less, 110° C. or less, 120° C. or less, 130° C. or less, 140° C. or less, 150° C. or less, 160° C. or less, 170° C. or less, 180° C. or less, 190° C. or less).

In some embodiments, the mat is heated for a period of time. In some embodiments, the mat is heated for an amount of time sufficient to fully melt (e.g., liquefy) or partially melt (e.g., soften, render tacky) the binder fiber. In some embodiments, the mat is heated for an amount of time sufficient to fully melt (e.g., liquefy) or partially melt (e.g., soften, render tacky) the sheath of the bicomponent fiber. In some embodiments, the mat is heated for 5 seconds to 20 minutes (e.g., 5 seconds to 10 seconds, 10 seconds to 20 seconds, 20 seconds to 30 seconds, 30 seconds to 45 seconds, 45 seconds to 1 minute, 1 minute to 5 minutes, 5 minutes to 10 minutes, 10 minutes to 15 minutes, 15 minutes to 20 minutes). In some embodiments, the mat is heated for 5 seconds or greater (e.g., 10 seconds or greater, 20 seconds or greater, 30 seconds or greater, 40 seconds or greater, 50 seconds or greater, 1 minute or greater, 2 minutes or greater, 4 minutes or greater, 6 minutes or greater, 8 minutes or greater, 10 minutes or greater, 12 minutes or greater, 14 minutes or greater, 16 minutes or greater, 18 minutes or greater). In some embodiments, the mat is heated for 20 minutes or less (e.g., 1 minute or less, 2 minutes or less, 4 minutes or less, 6 minutes or less, 8 minutes or less, 10 minutes or less, 12 minutes or less, 14 minutes or less, 16 minutes or less, 18 minutes or less). In some embodiments, the length of heating corresponds to the compression and/or formation of the mat, as discussed in more detail below. In some embodiments, the temperature is maintained throughout compression and/or formation of the mat into a composite material.

In some embodiments, for instance as shown in FIG. 6, the mat is compressed at 106. The mat can be compressed in one or more steps (e.g., 1 step, 2 steps, 3 steps, 4 steps, 5 steps, 6 steps). In some embodiments, the mat is compressed in a first step at a first pressure, and then compressed in a second step at a second pressure. In some embodiments, the mat is compressed in one step at a first pressure. In some embodiments, the mat is compressed in a first step at a first pressure into a two-dimensional (2D) panel (106 of FIG. 6). In some embodiments, the 2D panel is then formed in a second step into a contoured 2D panel or three-dimensional (3D) shape by, e.g., compression molding, laminating, thermoforming, vacuum forming, vacuum bag forming, or variations and combinations thereof (110 of FIG. 6). In some embodiments, the 2D panel is cut bonded before forming into a 3D structure. In some embodiments, the second step occurs immediately after the first step. In some embodiments, the second step occurs at a time after the first step. In some embodiments, the first and second steps are performed by the same entity. In some embodiments, the first step can be performed by a first entity and the second step can be performed by a second entity, e.g., a first entity compresses the mat into the 2D panel and a second entity then forms the 2D panel into a contoured 2D panel or a 3D shape. The 2D panel can be reheated before forming into the contoured 2D panel or 3D shape.

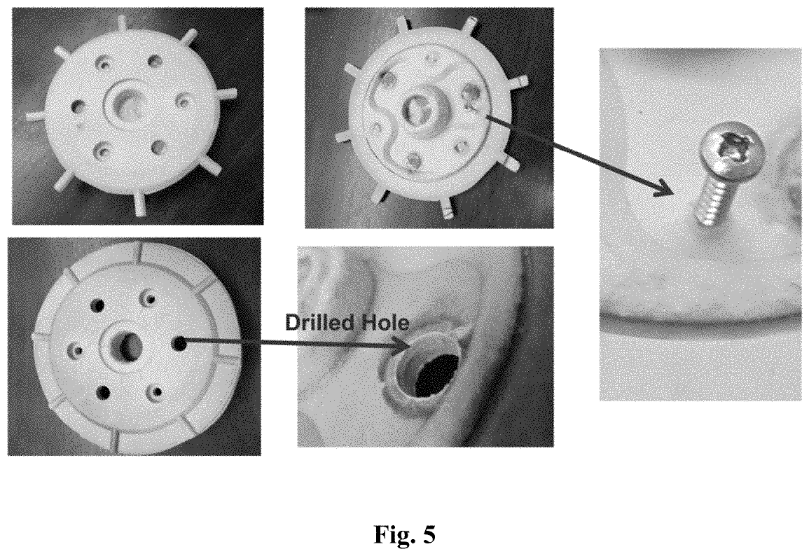

In some embodiments, a 3D form of the composite material can be obtained through a molding process and can use a 2D or 3D mold. In some embodiments, such as shown in FIG. 5, the mat is compressed in a first step into a 3D mold to directly create a 3D shape. For instance, a provided airlaid or wetlaid mat can be molded into predetermined shapes and figures to produce the composite material. In some embodiments, the 2D panel is compressed or formed into a contoured 2D panel (e.g., with beveled or chamfered edges or a slight curvature to the panel) that can optionally be further formed into a 3D shape as discussed below.

The airlaid or wetlaid mat can be compressed in a first step into a 3D mold at a first pressure from 800 psi to 6000 psi as discussed herein. The 3D mold can be heated, or heat can be applied to the airlaid or wetlaid mat, in order to fully or partially melt the binding material (e.g., at a temperature of from 40° C. to 200° C. including from 150° C. to 180° C. as discussed herein). The 3D mold can be optimized to generate a uniformly dense 3D shape after the compression. Such optimization can comprise, for example and not limitation, modifying the spacing between the halves or sections of the mold to have a uniform spacing (i.e., maintaining a uniform distance between the mold pieces).

In any of the foregoing embodiments, the contoured 2D panel or the 3D shape has the same or substantially similar density and mechanical properties as the 2D panel. In any of the foregoing embodiments, the first and/or second step occurs at a temperature above the melting point of the binding material. In any of the foregoing embodiments, the contoured 2D panel or the 3D shape is cooled after the first and/or second step, respectively, to a temperature below the melting point of the binding material (108 and 112 of FIG. 6). The cooling can be either active (e.g., by passing air over the contoured 2D panel or the 3D shape) or passive (e.g., by removing the contoured 2D panel or the 3D shape from the heat source). In some embodiments, the heat is maintained throughout the compressing and/or forming steps. In some embodiments, the cooling occurs before the pressure applied in the first and/or second steps is released. In some embodiments, the cooling occurs after the pressure applied in the first and/or second steps is released. It is possible that the contoured 2D panel and/or 3D shape can experience some springback if the cooling occurs after the pressure is released as the binding material may still be fully or partially melted and may undergo some contraction or other change in shape, density, or other mechanical property upon release of the pressure.

In some embodiments, the first pressure and/or second pressure is from 0 psi to 600 psi (e.g., 0 psi to 100 psi, 100 psi to 200 psi, 200 psi to 300 psi, 300 psi to 400 psi, 400 psi to 500 psi, 500 psi to 600 psi). In some embodiments, the first and/or second pressure is 600 psi or less (e.g., 500 psi or less, 400 psi or less, 300 psi or less, 200 psi or less, 100 psi or less, 0 psi or less, −10 psi or less, −15 psi or less, −30 psi or less). In some embodiments, the first and/or second pressure includes a negative vacuum pressure. In some embodiments, the first and/or second pressure is 600 psi or greater (e.g., 620 psi or greater, 640 psi or greater, 660 psi or greater, 680 psi or greater, 700 psi or greater, 720 psi or greater, 740 psi or greater, 760 psi or greater, 780 psi or greater, 800 psi or greater, 820 psi or greater, 840 psi or greater, 860 psi or greater, 880 psi or greater, 890 psi or greater, 900 psi or greater, 910 psi or greater, 920 psi or greater, 930 psi or greater, 940 psi or greater, 950 psi or greater, 960 psi or greater, 970 psi or greater, 980 psi or greater, 990 psi or greater, 1000 psi or greater).

In some embodiments, the first and/or second pressure is 1000 psi or greater (e.g., 1100 psi or greater, 1200 psi or greater, 1300 psi or greater, 1400 psi or greater, 1500 psi or greater, 1600 psi or greater, 1700 psi or greater, 1800 psi or greater, 1900 psi or greater, 2000 psi or greater, 2100 psi or greater, 2200 psi or greater, 2300 psi or greater, 2400 psi or greater, 2500 psi or greater). In some embodiments, the first and/or second pressure is 3000 psi or greater (e.g., 3100 psi or greater, 3200 psi or greater, 3300 psi or greater, 3400 psi or greater, 3500 psi or greater, 3600 psi or greater, 3700 psi or greater, 3800 psi or greater, 3900 psi or greater, 4000 psi or greater, 4100 psi or greater, 4166 psi or greater, 4200 psi or greater, 4300 psi or greater, 4400 psi or greater, 4500 psi or greater, 4600 psi or greater, 4700 psi or greater, 4800 psi or greater, 4900 psi or greater, 5000 psi or greater, 5100 psi or greater, 5200 psi or greater, 5300 psi or greater, 5400 psi or greater, 5500 psi or greater, 5600 psi or greater, 5700 psi or greater, 5800 psi or greater, 5900 psi or greater, 6000 psi or greater, 6100 psi or greater, 6200 psi or greater, 6300 psi or greater, 6400 psi or greater, 6500 psi or greater, 6600 psi or greater, 6700 psi or greater, 6800 psi or greater, 6900 psi or greater, 7000 psi or greater). In some embodiments, the mat is an airlaid mat compressed to pressures up to or including 4000 psi, 5000 psi, or up to or including 6000 psi, at a temperature of at least 40° C. and up to 200° C., including at least 120° C. and up to 180° C.

In some embodiments, the first pressure is greater than the second pressure. In some embodiments, the first pressure is between 800 psi and 6000 psi. In some embodiments, the first pressure is between 850 psi and 5000 psi. In some embodiments, the first pressure is between 850 psi to 3000 psi. In some embodiments, the first pressure is between 850 psi to 1500 psi. In some embodiments, the first pressure is between 850 psi to 1200 psi. In some embodiments, the first pressure is between 1200 and 5000 psi. In some embodiments, the first pressure is between 1500 psi and 5000 psi. In some embodiments, the first pressure is between 1600 psi and 5000 psi. In some embodiments, the first pressure is 3000 psi to 5000 psi. In some embodiments, the first pressure is about 4166 psi. In some embodiments, the first pressure is about 5000 psi. In some embodiments, the second pressure is between 15 psi and 500 psi. In some embodiments, the second pressure is between 15 psi and 50 psi. In some embodiments, the second pressure is a vacuum pressure or negative gauge pressure.

In some embodiments, the composite material can be made by compressing multiple layers (e.g., 3 layers) of mats (e.g., airlaid mats or wetlaid mats) with each layer of a certain weight (e.g., 2100 gsm), by either compressing the layers together or compressing each layer separately and adding the layers together after the first compression step to manipulate the type and overall properties of the resulting composite material.

In some embodiments, an airlaid mat or wetlaid mat is heated and compressed in a first step at a first pressure into a 2D panel, cut, and then compressed or formed in a second step at a second pressure into a 3D shape. In some embodiments, an airlaid mat or wetlaid mat is heated and compressed in a first step at a first pressure in a 3D mold into a 3D shape.

In some embodiments, the binding material is combined with the fibrous material in the mat through a combining process. In some embodiments, the fibrous material is made into an airlaid mat without use of a binding material. In some embodiments, the fibrous material is made into a wetlaid mat without use of a binding material. Suitable examples of a combining process to combine the binding material and the fibrous material include needling, hydroentangling, adhesive bonding, spray bonding, thermal bonding, calendar bonding, through-air bonding, infrared bonding, ultrasonic bonding, welding, chemical bonding, felting, carding, airlaid, wetlaid, impaction, latex-bonding (e.g., by spraying web on top and bottom with a latex like styrene butadiene or acrylic, for instance), or any combination thereof.

The composite materials can also include additives. In some embodiments, the additives can be introduced with the fibrous material and/or the binding material. In some embodiments, the additives can be introduced during the mat making process. In some embodiments, the additives can be introduced during the heating and/or compressing steps of making the composite material. In some embodiments, the additives can be applied to the composite material after its formation.

In some embodiments, to improve the fire-retardant properties of the composite material, the composite material can be coated with a fire-retardant gel coat and/or other flame-retardant material. As used herein, “fire retardant” and “flame retardant” can refer to a substance that is used to slow or stop the spread of fire or reduce its intensity. In some embodiments, the composite materials are fire retardant.

In some embodiments, the additives include fillers (e.g., clay, carbonates), dyes, colorants, water repellants, grease repellants, antifungal agents, antibacterial agents, bioactive materials for sizing, biomaterials (e.g., lignin or other biopolymers) for bonding material as matrix, anticorrosion agents, or a combination thereof. In addition, in some embodiments, the composite material is surface treated for functionality (e.g., water repellant) or decorative finish (e.g., gel-coating, painting, PLA film on plates, etc.) as shown in FIG. 6 at 108. In some embodiments, the properties of the composite material can be manipulated by the manufacturing process (e.g., lower compression pressure can create increased surface porosity) to facilitate surface treatment (e.g., increased surface porosity can allow paint to bond to the surface of the composite material with greater ease).

Some embodiments of this disclosure include composite materials that can rival pure wood in appearance, strength, and durability, without sacrificing the molding ability and formability of composites and plastics. In some embodiments, fibrous material can be blended with a small amount of binding material for strength and can be formed into mats using a non-woven process such as airlaying. The airlaid mats can be placed into three-dimensional molds and compressed to high pressures to create a material with the visual qualities of wood and superior mechanical properties than other common wood composites. Since some embodiments of the composite materials disclosed herein can be made from naturally occurring fiber without additional resin, the environmental impact of the process can be lower than alternatives. Thus, in some embodiments, the composite material produced can be formed more easily than wood and can be much stronger than wood alternatives, providing a cheaper and more durable building material. In some embodiments, the composite material has the advantage of being biosourced and biodegradable (e.g., if bonded with PLA or if wetlaid without binding materials). For instance, some embodiments containing no resin or coating would have a very small environmental impact. In some embodiments, the highly compressed composite materials can be recycled to provide a cellulosic fiber source to manufacture more highly compressed cellulosic fiber composite materials.

In some embodiments, the composite materials were highly compressed airlaid mats shown to have a flexural modular and/or flexural strength comparable and/or superior to other products on the market, as shown below in Table 1.

TABLE 1

| | | Flexural | Flexural |
|---|---|---|---|
| | | Modulus | Strength |
| Sample ID | | (GPa) | (MPa) |
| Highly compressed air-laid mats | | 5.9-7.7 | 114-141 |
| Clear Wood | | 10-13.6 | 67-105 |
| Wood-based | Hardboard | 3.1-5.5 | 31-56.5 |
| Composites | Medium-density | 2.9-4.38 | 24.6-37.4 |
| | Fiberboard | | |
| | Particleboard | 2.7-4.1 | 15.1-24.1 |
| Panel Products | Oriented Strandboard | 4.4-7.9 | 21.8-38.8 |
| | (OSB) | | |
| | Plywood | 6.9-8.5 | 33.7-42.6 |
| Wood-Non wood | Wood-Plastic | 1.5-4.2 | 25.4-52.3 |
| Composites | | | |
| Structural Timber | Glued Laminate | 9-13.4 | 28.6-62.6 |
| Products | Timber | | |
| | Laminated Veneer | 8.9-19.3 | 33.8-86.1 |
| | Lumber | | |

A person of ordinary skill in the art would recognize that these properties depend on, and thus can be manipulated during manufacturing by, the binding material percentage, thickness of resulting composite material, etc. Accordingly, a person of ordinary skill in the art would recognize from the teachings of the present disclosure how to vary manufacturing to achieve desired properties. For instance, a known 2200 gsm composite material with an average thickness of 3 mm could be comparable to known wood products, but the composite materials disclosed herein can be made thinner without sacrificing performance comparable to known wood products. FIG. 5 illustrates a composite material of the present disclosure formed into a 3D mold, wherein the resulting 3D composite material can be drilled or screwed comparable to a known wood product. The flexural strength and flexural modulus for the highly compressed composite material in Table 1 are for a 2200 gsm composite of 1.41 to 2.14 mm thickness, but the flexural strength and flexural modulus for highly compressed composite materials of the present disclosure can depend on and be manipulated by a number of variables (e.g., basis weight, pressure, density, thickness, binder material type, binder material amount, etc.). As described below, the term “composite material” includes (i) a 2D panel which has undergone a single compression at a higher pressure; (2) a contoured 2D panel that has undergone a second compression or formation at a lower pressure; and (iii) a 3D shape that has undergone a second compression or formation at a lower pressure.

In some embodiments, the composite material can have a weight of 40 gsm (grams per square meter) to 4000 gsm, including 40 gsm to 500 gsm. In some embodiments, multiple mats of a certain weight can be compressed in order to arrive at a composite material with a weight equal to the sum of the weights of the mats, e.g., three mats of 1000 gsm can be compressed according to the methods described herein into a composite material of 3000 gsm. For instance, the composite material can have a weight of 350 gsm or greater (e.g., 400 gsm or greater, 500 gsm or greater, 600 gsm or greater, 700 gsm or greater, 800 gsm or greater, 900 gsm or greater, 1000 gsm or greater, 1500 gsm or greater, 1700 gsm or greater, 2000 gsm or greater, 2100 gsm or greater, 2300 gsm or greater, 2500 gsm or greater, 2700 gsm or greater, 3000 gsm or greater, or 3500 gsm or greater). For instance, the composite material can have a weight of 4000 gsm or less (e.g., 3750 gsm or less, 3250 gsm or less, 3000 gsm or less, 2750 gsm or less, 2500 gsm or less, 2250 gsm or less, 2000 gsm or less, 1750 gsm or less, 1500 gsm or less, 1250 gsm or less, 1000 gsm or less, 750 gsm or less, or 500 gsm or less). For instance, the composite material can have a weight of 350 gsm to 4000 gsm (e.g., 350 gsm to 400 gsm, 400 gsm to 500 gsm, 500 gsm to 600 gsm, 600 gsm to 700 gsm, 700 gsm to 800 gsm, 800 gsm to 900 gsm, 900 gsm to 1000 gsm, 1000 gsm to 1500 gsm, 1500 gsm to 2000 gsm, 2000 gsm to 2500 gsm, 3000 gsm to 3500 gsm, or 3500 gsm to 4000 gsm. A person of ordinary skill in the art would recognize that the weight of the composite material can be expanded above or below the ranges (above in this paragraph) as needed for various other applications and uses. The method of making the composite materials can be modified as disclosed herein to achieve a particular thickness or density for the desired application.

In some embodiments, the thickness of the composite materials is from 1.3 mm to 100 mm (e.g., 1.3 mm to 2 mm, 2 mm to 5 mm, 5 mm to 10 mm, 10 mm to 20 mm, 20 mm to 30 mm, 30 mm to 40 mm, 40 mm to 50 mm, 50 mm to 60 mm, 60 mm to 70 mm, 70 mm to 80 mm, 80 mm to 90 mm, 90 mm to 100 mm). In some embodiments, the thickness of the composite materials is 1.3 mm or greater (e.g., 1.5 mm or greater, 2 mm or greater, 5 mm or greater, 10 mm or greater, 20 mm or greater, 30 mm or greater, 40 mm or greater, 50 mm or greater, 60 mm or greater, 70 mm or greater, 80 mm or greater, 90 mm or greater). In some embodiments, the thickness of the composite materials is 100 mm or less (e.g., 90 mm or less, 80 mm or less, 70 mm or less, 60 mm or less, 50 mm or less, 40 mm or less, 30 mm or less, 20 mm or less, 10 mm or less, 5 mm or less, 2 mm or less, 1.5 mm or less). In some embodiments, the thickness of the composite material is from 1 mm to 5 mm (e.g., 1.5 mm to 3.3 mm). In some embodiments, the thickness of the composite material is from 0.3 mm to 10 mm.

The density of the composite material can be controlled by the step wherein the highest compression occurs. In some embodiments, the density of the composite material is from 0.7 g/cm³ to 1.5 g/cm³ (e.g., 0.7 g/cm³ to 0.8 g/cm³, 0.8 g/cm³ to 0.9 g/cm³, 0.9 g/cm³ to 1.0 g/cm³, 1.0 g/cm³ to 1.1 g/cm³, 1.1 g/cm³ to 1.2 g/cm³, 0.7 g/cm³ to 0.9 g/cm³, 0.9 g/cm³ to 1.2 g/cm³). In some embodiments, the density of the composite material is 0.7 g/cm³ or greater (e.g., 0.8 g/cm³ or greater, 0.9 g/cm³ or greater, 1.0 g/cm³ or greater, 1.1 g/cm³ or greater). In some embodiments, the density of the composite material is 1.5 g/cm³ or less (e.g., 1.4 g/cm³ or less, 1.3 g/cm³ or less, 1.2 g/cm³ or less, 1.1 g/cm³ or less, 1.0 g/cm³ or less, 0.9 g/cm³ or less, 0.8 g/cm³ or less). In some embodiments, the density of the composite material is from 0.8 g/cm³ to 1.5 g/cm³, including from 1.1 g/cm³ to 1.4 g/cm³.

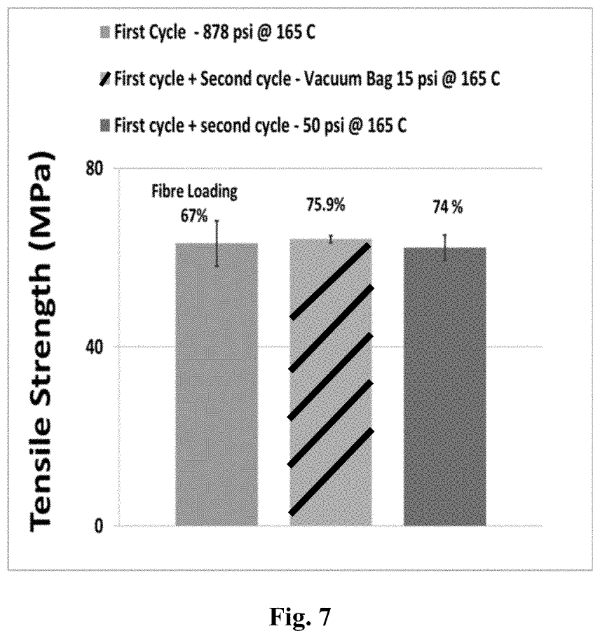

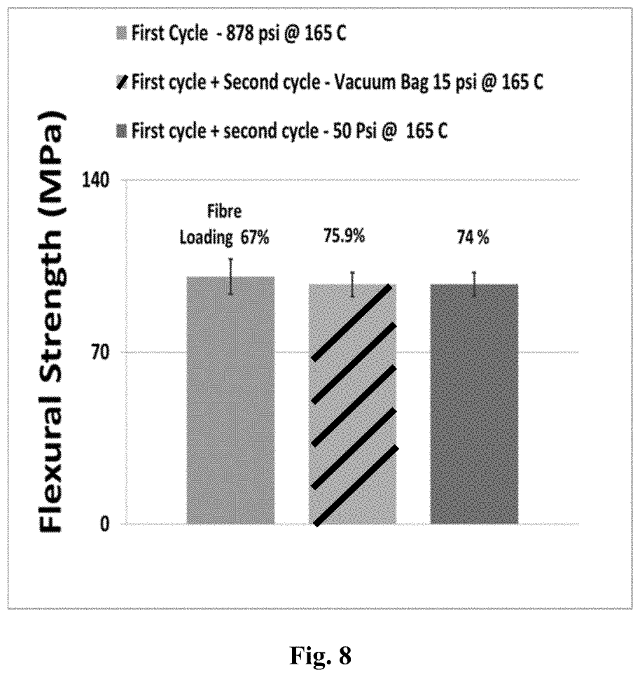

Embodiments of the present disclosure can provide highly compressed composite materials with mechanical performance suitable for building applications and can be joined to other materials by various attachment means or fasteners including nails and screws. A formation of the composite material can be obtained through a molding process and can use a 2D or 3D mold. In some embodiments, a 2D panel is created, cut bonded, and formed into a 3D structure with, for instance, heat and/or pressure. In some embodiments, such as shown in FIG. 5, the mat is compressed or formed directly into a 3D mold to directly create a 3D object. For instance, a provided airlaid mat can be molded into predetermined shapes and figures to produce the composite material. Suitable examples of a molding process to form the composite material include compression molding, laminating, thermoforming, vacuum forming, vacuum bag forming, or variations and combinations thereof. The 3D structure has the same or substantially similar density and/or mechanical properties as the 2D panel, as shown in FIGS. 7-8.

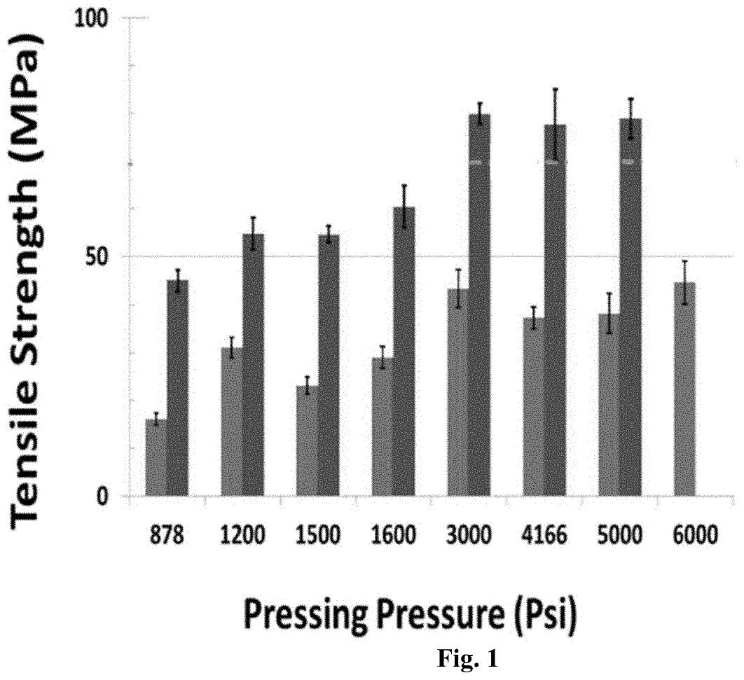

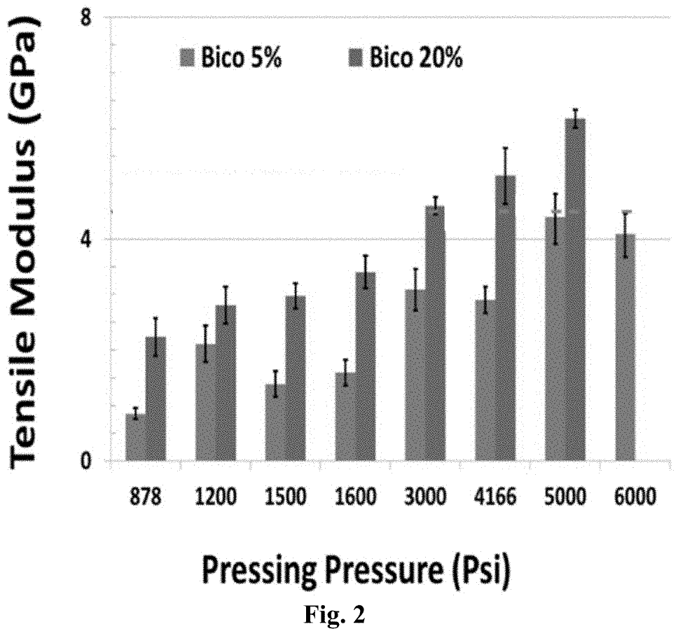

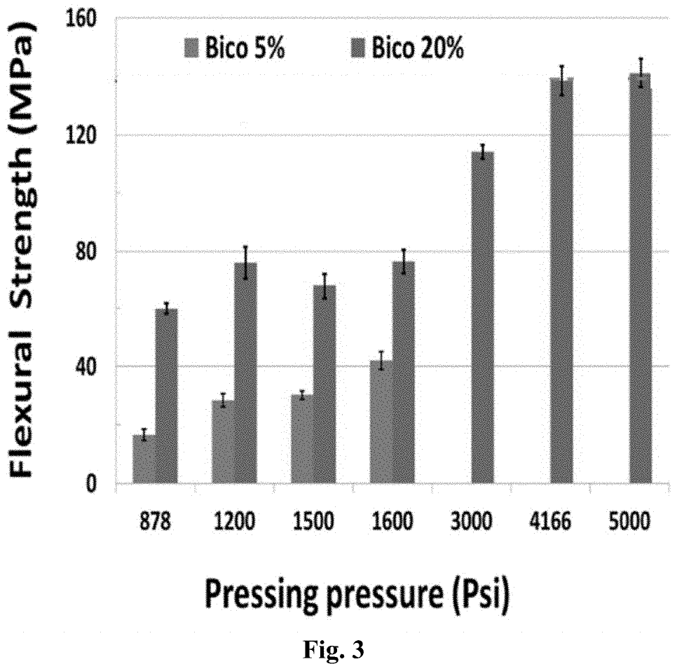

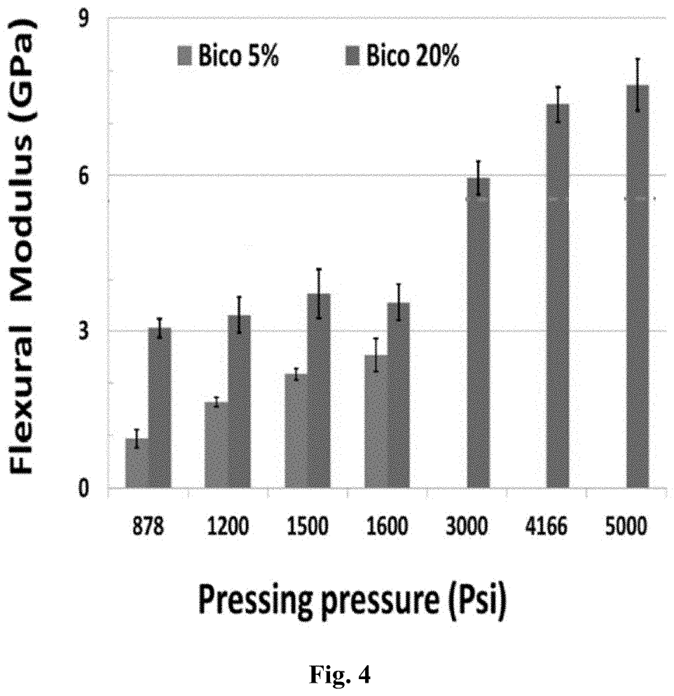

The composite materials can have tensile strength of 15 MPa to 100 MPa (some of which are shown in FIG. 1), and flexural strength of about 15 MPa to 150 MPa (some of which are shown in FIG. 3). The manufactured highly compressed composite materials have a tensile modulus of 0.75 GPa to 10 GPa (some of which are shown in FIG. 2), and a flexural modulus of 0.75 GPa to 10 GPa (some of which are shown in FIG. 4). The tensile strength, tensile modulus, flexural modulus, and flexural strength in FIGS. 1-4 for the presently disclosed composite materials can depend on and be manipulated by a number of variables (e.g., basis weight, pressure, density, thickness, type of binding material, amount of binding material, etc.). For instance, doubling the basis weight of the mat could increase the mechanical properties of the resulting composite material.

In some embodiments, the composite materials can present a tensile strength of 15 MPa or greater, 30 MPa or greater, 35 MPa or greater, 40 mPa or greater, 45 MPa or greater, 50 MPa or greater, 55 MPa or greater, 60 MPa or greater, 65 MPa or greater, 70 MPa or greater, 75 MPa or greater, or 80 MPa or greater. In some embodiments, the composite materials have a tensile strength of 50 MPa to 90 MPa, including 60 MPa to 80 MPa.

In some embodiments, the composite materials can present a flexural strength of 15 MPa or greater, 40 MPa or greater, 50 MPa or greater, 60 MPa or greater, 70 MPa or greater, 80 MPa or greater, 90 MPa or greater, 100 MPa or greater, 110 MPa or greater, 120 MPa or greater, 130 MPa or greater, or 140 MPa or greater. In some embodiments, the composite materials have a flexural strength of 15 MPa to 150 MPa, including 60 MPa to 150 MPa and 80 MPa to 140 MPa.

In some embodiments, the composite materials can present a tensile modulus of 0.75 GPa or greater, 4.5 GPa or greater, 5.0 GPa or greater, 5.5 GPa or greater, or 6.0 GPa or greater. In some embodiments, the composite materials have a tensile modulus of 1 GPa to 9 GPa, including 3 GPa to 7.5 GPa and 3.5 GPa to 7 GPa.

In some embodiments, the highly compressed composite materials can present a flexural modulus of 0.75 GPa or greater, 5.5 GPa or greater, 6.0 GPa or greater, 6.5 GPa or greater, 7.0 GPa or greater, 7.5 GPa or greater, or 8.0 GPa or greater. In some embodiments, the composite materials can have a flexural modulus of 3 GPa to 9 GPa, including 4 GPa to 8 GPa and 4 GPa to 7 GPa.

In some embodiments, the composite materials have shown modulus properties of elasticity of from 5.9 GPa to 7.7 GPa, and modulus properties of rupture of from 114 MPa to 141 MPa.

The composite materials can be used in a variety of applications. For instance, the composite materials can be used on several applications such as thin and performing semi-structural or structural panels for building applications. A person of ordinary skill in the art would recognize from the present disclosure that the resulting composite materials can be manufactured to have any desired 2D and 3D shapes, including for instance to manufacture interior parts for automotive or mass transit applications. In some embodiments, the composite materials can be used to make products (e.g., furniture) with complex geometries in one step. In some embodiments, the composite materials can be used as support for acrylic sheets to produce Jacuzzis or others.

The following examples are provided by way of illustration but not by way of limitation.

### EXAMPLES

### Example 1

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. One set of composite materials were made with 95 wt % wood pulp fiber and 5 wt % bicomponent fiber, by weight of the composite materials. Another set of composite materials were made of 80 wt % wood pulp fiber and 20 wt % bicomponent fiber, by weight of the composite materials. The sets of composite materials were heated at a temperature of 180° C. for 10 minutes. The mats were then compressed to the desired pressure and held at that pressure and temperature (180° C.) for 10 minutes. The mats were then cooled under similar pressure to a temperature of 40-45° C. The resulting composite material was 2200 gsm.

Tensile strength and tensile modulus measurements were acquired for each composite, as shown in FIGS. 1-2. Tensile strength was measured according to ASTM D638-14 (2014) and tensile modulus was measured according to ASTM D638-14 (2014) as shown in Table 2 below.

### Results

FIGS. 1-2 show a graphical representation comparing the tensile strength and tensile modulus of reinforced composites wherein the pressure during compression and bicomponent fiber composition was varied.

TABLE 2

| | Bi- | | | | Compo- | |
|---|---|---|---|---|---|---|
| | compo- | | | | site | |
| | nent | | Tensile | Tensile | Thick- | |
| | Fiber | Pressure | Strength | Modulus | ness | Density |
| Composite | (wt %) | (psi) | (MPa) | (GPa) | (mm) | (g/cm³) |
| A | 5% | 878 | 16.09 | 0.85 | 2.09 | 0.79 |
| B | 20% | 878 | 45.05 | 2.23 | 2.08 | 0.93 |
| C | 5% | 1200 | 31.06 | 2.11 | 1.98 | 0.83 |
| D | 20% | 1200 | 54.76 | 2.81 | 1.94 | 1.05 |
| E | 5% | 1500 | 23.16 | 1.39 | 2.04 | 0.87 |
| F | 20% | 1500 | 54.62 | 2.97 | 2.14 | 1.06 |
| G | 5% | 1600 | 29.04 | 1.59 | 1.76 | 0.94 |
| H | 20% | 1600 | 60.39 | 3.41 | 1.82 | 1.09 |
| I | 5% | 3000 | 43.40 | 3.09 | 1.68 | 1.07 |
| J | 20% | 3000 | 79.83 | 4.6 | 1.75 | 1.2 |
| K | 5% | 4166 | 37.37 | 2.9 | 1.57 | 1.05 |
| L | 20% | 4166 | 77.56 | 5.14 | 1.61 | 1.22 |
| M | 5% | 5000 | 38.26 | 4.4 | 1.48 | 1 |
| N | 20% | 5000 | 78.83 | 6.18 | 1.62 | 1.24 |
| O | 5% | 6000 | 44.61 | 4.09 | 1.41 | TBD |

As illustrated above, the reinforced composite compression pressures and binding material content can have an important impact on the mechanical properties of the resulting reinforced composite. For instance, increased binding material content coupled with increased compression can exhibit a tensile strength and a tensile modulus exceeding the required tensile strength and modulus for mass transit, car interior and/or building applications.

### Example 2

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. One set of composite materials were made with 95 wt % wood pulp fiber and 5 wt % bicomponent fiber, by weight of the composite materials. Another set of composite materials were made of 80 wt % wood pulp fiber and 20 wt % bicomponent fiber, by weight of the composite materials. The composite materials were heated at a temperature of 180° C. for 10 mins. The mats were then compressed to the desired pressure and held at that pressure and temperature (180° C.) for 10 mins. The mats were then cooled under similar pressure to a temperature of 40-45° C. The resulting composite material was 2200 gsm.

Flexural strength and flexural modulus measurements were acquired for each composite, as shown in FIG. 3a-3b. Flexural strength was measured according to ASTM D790-17 (2017) and flexural modulus was measured according to ASTM D790-17 (2017), as shown in Table 3 below.

### Results

FIGS. 3-4 show a graphical representation comparing flexural strength and flexural modulus of reinforced composites wherein the pressure during compression and bicomponent fiber composition was varied.

TABLE 3

| | Bi- | | | | Compo- | |
|---|---|---|---|---|---|---|
| | compo- | | | | site | |
| | nent | | Flexural | Flexural | Thick- | |
| | Fiber | Pressure | Strength | Modulus | ness | Density |
| Composite | (wt %) | (psi) | (MPa) | (GPa) | (mm) | (g/cm³) |
| A | 5% | 878 | 16.62 | 0.95 | 2.09 | 0.79 |
| B | 20% | 878 | 60.03 | 3.05 | 2.08 | 0.93 |
| C | 5% | 1200 | 28.38 | 1.64 | 1.98 | 0.83 |
| D | 20% | 1200 | 76.09 | 3.31 | 1.94 | 1.05 |
| E | 5% | 1500 | 30.19 | 2.17 | 2.04 | 0.87 |
| F | 20% | 1500 | 67.87 | 3.72 | 2.14 | 1.06 |
| G | 5% | 1600 | 42.02 | 2.54 | 1.76 | 0.94 |
| H | 20% | 1600 | 76.52 | 3.55 | 1.82 | 1.09 |
| I | 5% | 3000 | TBD | TBD | 1.68 | 1.07 |
| J | 20% | 3000 | 114.2 | 5.96 | 1.75 | 1.2 |
| K | 5% | 4166 | TBD | TBD | 1.57 | 1.05 |
| L | 20% | 4166 | 138.62 | 7.36 | 1.61 | 1.22 |
| M | 5% | 5000 | TBD | TBD | 1.48 | 1 |
| N | 20% | 5000 | 141.06 | 7.73 | 1.62 | 1.24 |

As illustrated above, the reinforced composite compression pressures and binding material content can have an important impact on the mechanical properties of the resulting reinforced composite. For instance, increased binding material content coupled with increased compression can exhibit a flexural strength and flexural modulus exceeding the required flexural strength and flexural modulus for mass transit, car interior and/or building applications.

### Example 3

### Methods

Wood pulp fiber (SBSK pulp) and bicomponent fibers (TREVIRA, 6 mm, 1.3 dtex, PET core and PE sheath) were obtained and used to form an airlaid mat using conventional airlaid processes. A set of composite materials were made with 80 wt % wood pulp fiber and 20 wt % bicomponent fiber, by weight of the composite material. The airlaid mats were inserted on a 3D mold corresponding to the shape of the composite materials of FIG. 5. The 3D mold was heated up to 180° C. before the transfer of several airlaid mats to the mold. The 3D mold was then partially closed to heat up the airlaid mats at a temperature of 180° C. for 10 mins. The mold was then completely closed and the mats were then compressed on the mold to the desired pressure and held at that pressure and temperature (180° C.) for 10 mins. The 3D composite material obtained from highly compressing the airlaid mats was cooled to temperature of 40-45° C. without applying any pressure. The composite material, once removed from the mold, was not cooled under pressure. The 3D composite was then cut using a saw, drilled and screwed in the same manner as would be used for a wood product, as shown in FIG. 5. See also the comparison of tensile strengths (FIG. 7) and flexural strengths (FIG. 8) for a composite material that has undergone a single compression at 878 psi, a composite material that has undergone a second forming via a vacuum bag, and a composite material that has undergone a second forming via compression at 50 psi. As can be seen in these Figures, the tensile strengths and flexural strengths are comparable for each of the three composite materials.

Further, as is clear from the content of the description, the present invention relates to one or more of the items as listed below, numbered from 1 to 23:

1. A composite material comprising:

from 1% to 99% by weight of a fibrous material comprising cellulosic fibers, by weight of the composite material; and

from 1% to 50% by weight of a binding material, by weight of the composite material,

wherein the composite material has a density of 0.8 g/cm³ to 1.5 g/cm³.

2. The composite material of item 1, wherein the binding material comprises a bicomponent fiber, a monocomponent fiber, or a combination thereof.
3. The composite material of items 1-2, wherein the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.
4. The composite material of items 1-3, wherein the density of the composite material is 1.1 g/cm³ to 1.4 g/cm³.
5. The composite material of items 1-4, wherein the composite material has a tensile strength of 15 MPa or greater, a flexural strength of 15 MPa or greater, or both.
6. The composite material of items 1-5, wherein the composite material has a tensile modulus of 0.75 GPa or greater, a flexural modulus of 0.75 GPa or greater, or both.
7. The composite material of items 1-6, wherein the composite material has a tensile strength of 50 MPa or greater, a flexural strength of 50 MPa or greater, or both.
8. A method comprising:

heating a mat to a temperature; and

compressing the mat at a first pressure of 800 psi to 6000 psi into one of a two-dimensional panel or a three-dimensional shape;

wherein the mat comprises:

from 1% to 99% by weight of a fibrous material comprising cellulosic fibers; and

from 1% to 50% by weight of a binding material,

wherein the temperature is above the melting point of the binding material, and

wherein the mat is incorporated into a composite material.

9. The method of item 8, further comprising cooling the two-dimensional panel or three-dimensional shape to a temperature below the melting point of the binding material after the step of compressing the mat.
10. The method of items 8-9, wherein the temperature is from 40° C. to 200° C.
11. The method of items 8-10, further comprising forming the two-dimensional panel into a contoured two-dimensional panel or three-dimensional shape at a second pressure of 15 psi to 500 psi.
12. The method of items 8-11, wherein the first pressure is from 850 psi to 5000 psi.
13. The method of items 8-12, wherein the heating and compressing are simultaneous.
14. The method of item 11, further comprising cooling the contoured two-dimensional panel or three-dimensional shape to a temperature below the melting point of the binding material after the step of forming the two-dimensional panel.
15. The method of items 8-14, wherein the first and/or second pressure occurs at a temperature is above the melting point of the binding material.
16. A composite material produced by the method of items 8-15, wherein the composite material has a density of 1.1 g/cm³ to 1.4 g/cm³.
17. The method of items 8-15, wherein the binding material comprises a bicomponent fiber, a monocomponent fiber, or a combination thereof.
18. The method of item 17, wherein the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.
19. The method of items 8-18, wherein the composite material has a tensile modulus of 0.75 GPa or greater, a flexural modulus of 0.75 GPa or greater, or both.
20. The method of items 8-18, wherein the composite material has a tensile strength of 50 MPa or greater, a flexural strength of 50 MPa or greater, or both.
21. The method of items 8-18, wherein the mat is a wetlaid mat.
22. The method of items 8-18, wherein the mat is an airlaid mat.
23. The method of item 11, wherein the density of the contoured two-dimensional panel or the three-dimensional shape is substantially the same as that of a two-dimensional panel.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

What is claimed is:

1. A composite material comprising:
from 1% to 99% by weight of a fibrous material comprising cellulosic fibers, by weight of the composite material; and
from 1% to 50% by weight of a binding material, by weight of the composite material,
wherein the composite material has a density of 0.8 g/cm³ to 1.5 g/cm³.

2. The composite material of claim 1, wherein the binding material comprises a bicomponent fiber, a monocomponent fiber, or a combination thereof.

3. The composite material of claim 1, wherein the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.

4. The composite material of claim 1, wherein the density of the composite material is 1.1 g/cm³ to 1.4 g/cm³.

5. The composite material of claim 1, wherein the composite material has a tensile strength of 15 MPa or greater, a flexural strength of 15 MPa or greater, or both.

6. The composite material of claim 1, wherein the composite material has a tensile modulus of 0.75 GPa or greater, a flexural modulus of 0.75 GPa or greater, or both.

7. The composite material of claim 1, wherein the composite material has a tensile strength of 50 MPa or greater, a flexural strength of 50 MPa or greater, or both.

8. A method comprising:
heating a mat to a temperature; and
compressing the mat at a first pressure of 800 psi to 6000 psi into one of a two-dimensional panel or a three-dimensional shape;
wherein the mat comprises:
from 1% to 99% by weight of a fibrous material comprising cellulosic fibers; and
from 1% to 50% by weight of a binding material,
wherein the temperature is above the melting point of the binding material, and
wherein the mat is incorporated into a composite material.

9. The method of claim 8, further comprising cooling the two-dimensional panel or three-dimensional shape to a temperature below the melting point of the binding material after the step of compressing the mat.

10. The method of claim 8, wherein the temperature is from 40° C. to 200° C.

11. The method of claim 8, further comprising forming the two-dimensional panel into a contoured two-dimensional panel or three-dimensional shape at a second pressure of 15 psi to 500 psi.

12. The method of claim 8, wherein the first pressure is from 850 psi to 5000 psi.

13. The method of claim 11, wherein the heating and compressing are simultaneous.

14. The method of claim 11, further comprising cooling the contoured two-dimensional panel or three-dimensional shape to a temperature below the melting point of the binding material after the step of forming the two-dimensional panel.

15. The method of claim 8, wherein the first and/or second pressure occurs at a temperature is above the melting point of the binding material.

16. A composite material produced by the method of claim 8, wherein the composite material has a density of 1.1 g/cm³ to 1.4 g/cm³.

17. The method of claim 8, wherein the binding material comprises a bicomponent fiber, a monocomponent fiber, or a combination thereof.

18. The method of claim 17, wherein the bicomponent fiber has (i) a core comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, and (ii) a sheath comprising polyethylene, polyethylene terephthalate, polyester, polypropylene, polyvinyl chloride, polystyrene, polymethacrylate, polyethylene naphthalate, polyvinyl alcohol, polyurethane, polyacrylonitrile, polylactic acid (PLA), polyhydroxyalkanoates (PHA) or combinations thereof, provided that the polymer in the sheath has a lower melting temperature than the polymer in the core.

19. The method of claim 8, wherein the composite material has a tensile modulus of 0.75 GPa or greater, a flexural modulus of 0.75 GPa or greater, or both.

20. The method of claim 8, wherein the composite material has a tensile strength of 50 MPa or greater, a flexural strength of 50 MPa or greater, or both.

21. The method of claim 8, wherein the mat is a wetlaid mat.

22. The method of claim 8, wherein the mat is an airlaid mat.

23. The method of claim 11, wherein the density of the contoured two-dimensional panel or the three-dimensional shape is substantially the same as that of a two-dimensional panel.
